(19) United States
(12) Patent Application Publication
(10) Pub. No.: US 2019/0102793 A1
(43) Pub. Date: Apr. 4, 2019

(54) Generating Media Content Using Connected Vehicle Data

(71) Applicant: Nissan North America, Inc., Franklin, TN (US)

(72) Inventor: Vikram Krishnamurthy, Marietta, GA (US)

(21) Appl. No.: 15/721,222

(22) Filed: Sep. 29, 2017

(51) Int. Cl. G06Q 30/02; G07C 5/00; G07C 5/08; G01C 22/02

(52) U.S. Cl. CPC G06Q 30/0255; G06Q 30/0204; G01C 22/02; G07C 5/085; G07C 5/008

(57) ABSTRACT

Systems, methods, and non-transitory computer readable storage media are described. A system comprises a memory and a processor that executes instructions stored in the memory to receive user data from a computing system operating a multi-user online platform. The user data indicates an exposure of a user of the multi-user online platform to first media content. The processor executes further instructions to receive vehicle data from a plurality of vehicles. The vehicle data indicates use of the plurality of vehicles by a plurality of operators. The processor executes further instructions to determine media content selection parameters by combining the user data and the vehicle, to select second media content using the media content selection parameters, and to transmit a message including the second media content to the computing system to cause an exposure of the user to the second media content.

### TECHNICAL FIELD

This application relates to connected vehicles, including systems, methods, and non-transitory computer readable media for generating media content using connected vehicle data.

### BACKGROUND

Media content such as digital images and videos can be generated. The generation of media content that utilizes data associated with users to receive a favorable or positive response when consumed or exposed to the users is costly and time-consuming. The present disclosure addresses such a need.

### SUMMARY

Disclosed herein are aspects, features, elements, and implementations for generating media content using connected vehicle data.

An aspect of the disclosed implementations includes a system comprising a memory and a processor that executes instructions stored in the memory to receive user data from a computing system operating a multi-user online platform. The user data indicates an exposure of a user of the multi-user online platform to first media content. The processor executes further instructions to receive vehicle data from a plurality of vehicles. The vehicle data indicates use of the plurality of vehicles by a plurality of operators. The processor executes further instructions to determine media content selection parameters by combining the user data and the vehicle, to select second media content using the media content selection parameters, and to transmit a message including the second media content to the computing system to cause an exposure of the user to the second media content.

An aspect of the disclosed implementations includes a method that comprises receiving user data from a computing system operating a multi-user online platform. The user data indicates an exposure of a user of the multi-user online platform to first media content. The method includes receiving vehicle data from a plurality of vehicles. The vehicle data indicates use of the plurality of vehicles by a plurality of operators. The method includes determining media content selection parameters by combining the user data and the vehicle, selecting second media content using the media content selection parameters, and transmitting a message including the second media content to the computing system to cause an exposure of the user to the second media content.

An aspect of the disclosed implementations includes a non-transitory computer-readable storage medium that includes executable instructions that, when executed by a processor, facilitate performance of operations, the operations comprising receiving user data from a computing system operating a multi-user online platform. The user data indicates an exposure of a user of the multi-user online platform to first media content. The operations include receiving vehicle data from a plurality of vehicles. The vehicle data indicates use of the plurality of vehicles by a plurality of operators. The operations include determining media content selection parameters by combining the user data and the vehicle, selecting second media content using the media content selection parameters, and transmitting a message including the second media content to the computing system to cause an exposure of the user to the second media content.

These and other aspects of the present disclosure are disclosed in the following detailed description of the embodiments, accompanying figures, and the appended claims.

### BRIEF DESCRIPTION OF THE DRAWINGS

The disclosed technology is best understood from the following detailed description when read in conjunction with the accompanying drawings (figures). It is emphasized that, according to common practice, the various features of the drawings are not to-scale. On the contrary, the dimensions of the various features are arbitrarily expanded or reduced for clarity.

FIG. 1 illustrates a block diagram of an example of an environment for generating media content using user data and vehicle data in accordance with implementations of this disclosure.

FIG. 2 illustrates a block diagram of an example internal configuration of a computing device of a cloud platform in accordance with implementations of this disclosure.

FIG. 3 illustrates a block diagram of an example of a telematic control unit of a vehicle used for generating media content in accordance with implementations of this disclosure.

FIG. 4 illustrates a block diagram of an example generation of probability distributions by a cloud platform in accordance with implementations of this disclosure.

FIG. 5 illustrates a diagram of an example of an aggregate vehicle probability distribution map in accordance with implementations of this disclosure.

FIG. 6 illustrates a block diagram of an example generation of purchase funnel status data by a cloud platform in accordance with implementations of this disclosure.

FIG. 7 illustrates a diagram of an example of a multi-user online platform cohesiveness distribution in accordance with implementations of this disclosure.

FIG. 8 illustrates a diagram of an example of a message generated using media content selection parameters in accordance with implementations of this disclosure.

FIG. 9 illustrates a flowchart of an example of a method for generating media content using user data and vehicle data in accordance with implementations of this disclosure.

FIG. 10 illustrates a flowchart of an example of a method for generating media content using user data and vehicle data in accordance with implementations of this disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Digital marketing campaigns can be focused on specific vehicles and specific users/drivers by providing multi-user online platform media content and targeted messaging using the disclosed technology. User data can be collected by the disclosed technology (e.g., a cloud platform) from users who “respond” (i.e., post, tweet, like, share, view, interact, etc.) directly or indirectly to the digital marketing campaigns of multi-user online platforms or from users that are active on the multi-user online platforms. Keywords (e.g., hashtags) or other multi-user online platform information can be used to identify the users who respond directly or indirectly to the digital marketing campaigns.

For example, users that “respond” to a digital marketing campaign on the Twitter multi-user online platform, can have certain information collected such as the text of their tweets, location information (i.e., tweeted from Calif.), and username. Additional information associated with the users that directly or indirectly respond to the digital marketing campaigns on the multi-user online platforms can be collected by the disclosed technology including but not limited to demographics, geo-location, income level, education level, engagement, interests, and personality insights associated with the users of the multi-user online platforms.

In addition to the user data, the disclosed technology can collect information associated with the mobility patterns/profiles (also referred to as mobility segments/levels) of users by leveraging connected vehicle data (e.g., via telematic control units of connected vehicles). The mobility levels can comprise mobility habits of the users that can be categorized into various categories including but not limited to “short trips”, “medium trips”, and “long trips” that are separated in terms of distance traveled by each respective vehicle. The distribution of trips associated with the users that is determined can be utilized to determine whether certain users are mobility fits for various vehicles associated with the digital marketing campaigns. For example, a vehicle that is developed for “long trips” would not be a good fit for a user that only uses their vehicle for short distance commutes between home and work. The connected vehicle data can include but is not limited to trip, journey, and vehicle health data at each ignition cycle or continuously during operation.

In the present disclosure, connected vehicle data (also referred to as vehicle data) is combined with user data to generate media content and corresponding targeted messaging for customers or users of multi-user online platforms. By combining the vehicle data with the user data (e.g., including but not limited to social media data associated with the user), the marketing campaign electronic records associated with the media content and corresponding targeted messaging of the digital marketing campaigns can be more readily generated and displayed (i.e., exposed) to the users. The electronic records can include the media content and the corresponding targeted messaging and additional information. The vehicle data can be utilized to determine mobility data such as mobility levels for the users and the mobility levels can be utilized to generate the media content and corresponding targeted messaging exposed to the user.

A method and system in accordance with the present disclosure generates media content and corresponding targeted messaging using both user data and vehicle data. The method and system generates the media content that can be transmitted to a user via a multi-user online platform. The media content can be generated by a cloud platform or a similar device by combining received user data associated with a user from at least one multi-user online platform with received vehicle data associated with a plurality of vehicles. The combination leads to a determination of media content selection parameters which are utilized by the cloud platform to select/generate the media content (along with the corresponding targeted message) which is then transmitted or displayed to the user via the at least one multi-user online platform.

As used herein, the terminology “driver” or “operator” may be used interchangeably. As used herein, the terminology “brake” or “decelerate” may be used interchangeably. As used herein, the terminology “computer” or “computing device” includes any unit, or combination of units, capable of performing any method, or any portion or portions thereof, disclosed herein.

As used herein, the terminology “example,” “embodiment,” “implementation,” “aspect,” “feature,” or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise, or clear from context, “X includes A or B” is intended to indicate any of the natural inclusive permutations. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Implementations of this disclosure provide technological improvements particular to computer networks and vehicles, for example, those concerning the extension of cloud computing to utilize vehicle data to generate media content targeted to users. The development of new ways to generate media content by combining user data associated with users and vehicle data associated with vehicles is fundamentally related to vehicle related computer networks and technology.

To describe some implementations in greater detail, reference is made to the following figures.

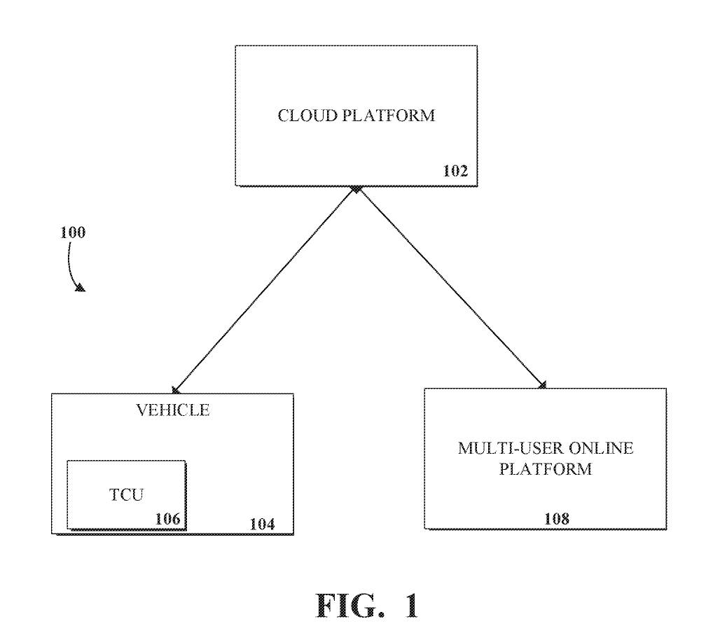

FIG. 1 illustrates a block diagram of an example of an environment 100 for generating media content using user data and vehicle data in accordance with implementations of this disclosure. The environment 100 includes a cloud platform 102, a vehicle 104 that includes a telematic control unit (TCU) 106, and a multi-user online platform 108. The cloud platform 102 can receive vehicle data from the vehicle 104 via the TCU 106 or directly from the vehicle 104. The vehicle data can be based on location (e.g., city, region) and is used to develop usage based segmentation or mobility levels (e.g., low mobility, moderate mobility, high mobility) associated with the vehicles and corresponding operators of the vehicles in a variety of geographic regions. The cloud platform 102 can also receive user data (also referred to as platform data) from the multi-user online platform 108. The user data can comprise multi-user online platform comments representing responses to various campaigns (i.e., digital marketing campaigns conducted on the multi-user online platform) by a user of the multi-user online platform or can comprise other information associated with the user's activity (e.g., time spent, profiles viewed, etc.) on the multi-user online platform.

The cloud platform 102 can receive vehicle data associated with a plurality of vehicles (that each include a TCU 106) that are each operated by one of a plurality of operators (also referred to as drivers). The cloud platform 102 can receive user data associated with a plurality of users of the multi-user online platform 108 or can receive user data from multiple different multi-user online platforms. The cloud platform 102 can receive user data associated with a plurality of users at the same time and can compare each respective user data to the vehicle data to generate the media content and corresponding targeted messaging for each user.

The cloud platform 102 can include an application for storing, displaying, and processing information and can include communication links for communicating with both the vehicle 104 and the multi-user online platform 108. The application of the cloud platform 102 can include a web interface and a plurality of cloud services. The application of the cloud platform 102 can be a vehicle OEM cloud application. The vehicle 104 can include a plurality of sensors that detect the data and information associated with the vehicle 104 via an onboard system serving as the TCU 106. For example, the data and information can comprise a location of the vehicle 104 and time-traveled information associated with the vehicle 104 (e.g., date, time, location, direction, etc.) that leads to a determination that the vehicle 104 traveled for 2 hours from a first location to a second location on a certain date.

In some implementations, the multi-user online platform 108 comprises a social media platform (also referred to as a social network) that enables users to engage with each other and other entities such as businesses via the social media platform and that further enables users to share information, comments, text, media content (e.g., images, videos, etc.) both publicly and privately using searchable hashtags and other searchable information. In some implementations, the TCU 106 is embedded within other sub-systems of the vehicle 104 and in other implementations, the TCU 106 is a stand-alone device that is installed into the vehicle 104.

After receiving both the user data and the vehicle data, the cloud platform 102 can determine a mobility segment (also referred to as a mobility level) of the user using the user data and can determine mobility levels of the plurality of operators that each operate a separate vehicle 104. The determined mobility level of the user can be matched against the determined mobility levels of the plurality of operators within various geographic locations (e.g., cities, regions, etc.) to confirm the mobility level of the user (e.g., by generating a mobility score based upon the matching) to enable the generation of the media content and the targeted (i.e., personalized or customized) messaging for the relevant mobility level of the user by the cloud platform 102. The generated media content can be transmitted by the cloud platform 102 to the user via the multi-user online platform 108 for exposure to the user.

In addition to the mobility level, the media content and targeted messaging can be generated (i.e., further customized) using purchase funnel status data that is determined using the user data. The purchase funnel status data can comprise an interest level of the user including but not limited to a “low interest”, a “medium interest”, a “high interest”, and an “extremely high interest” level based upon where the user resides within the purchase funnel (e.g., awareness data value, familiarity data value, OaO or consideration data value, shopping data value, purchase data value). Each mobility level can be divided into purchase funnel status data sub-segments so that the media content and targeted messaging can be even further tailored. For example, a user that has a “high mobility” mobility level but a “low interest” level can be exposed to a different generated media content and targeted messaging in comparison to another user that also has a “high mobility” mobility level but has an “extremely high interest” level.

In addition to determining mobility levels using the vehicle data, each vehicle can be scored based on their need for certain types of maintenance. The determination of certain types of maintenance can be based on driving behavior and the vehicle health data received by the cloud platform and from the connected vehicle (e.g., from the telematic control unit of the connected vehicle). The vehicle data can also be used to determine driving behavior that can be used for usage based insurance. The scoring can be done from 0 to 100 where 100 denotes a “very good” driver who should receive a discount on his/her insurance.

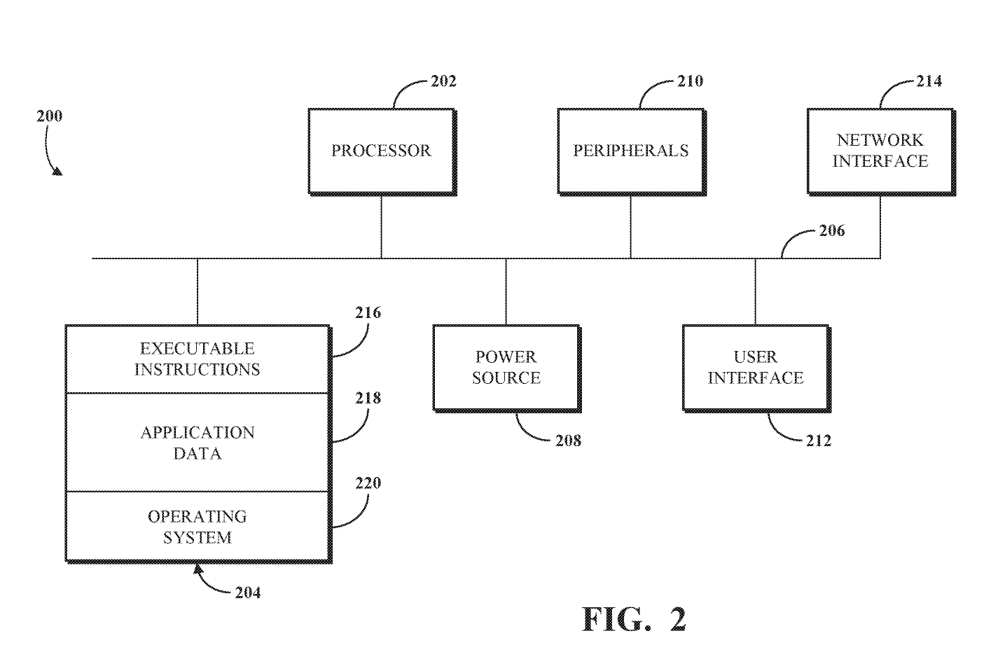

FIG. 2 illustrates a block diagram of an example internal configuration of a computing device 200 of a cloud platform (e.g., the cloud platform 102 of FIG. 1) in accordance with implementations of this disclosure. The computing device 200 includes components or units, such as a processor 202, a memory 204, a bus 206, a power source 208, peripherals 210, a user interface 212, and a network interface 214. One of more of the memory 204, the power source 208, the peripherals 210, the user interface 212, or the network interface 214 can communicate with the processor 202 via the bus 206. The computing device 200 can comprise a variety of computing devices including but not limited to a smartphone, a laptop, a desktop computer, a computer, a server device, any electronic device capable of connecting a user to the cloud platform, and any combination thereof.

The processor 202 is a central processing unit (CPU), such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may be volatile memory or non-volatile memory. For example, the volatile memory of the memory 204 can be a DRAM module (e.g., DDR SDRAM) or another form of volatile memory. In another example, the non-volatile memory of the memory 204 can be a disk drive, a solid-state drive, flash memory, Phase-Change Memory (PCM), or another form of non-volatile memory configured for persistent electronic information storage. The memory 204 may also include other types of devices, now existing or hereafter developed, configured for storing data or instructions for processing by the processor 202.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for generating media content using vehicle data and user data stored within the application data 218 (or database) of the memory 204. The application data 218 can include vehicle, data, user data, database data (e.g., database catalogs or dictionaries), or the like. The operating system 220 can be, for example, Microsoft Windows®, Mac OS X®, or Linux®; an operating system for a small device, such as a smartphone or tablet device; or an operating system for a large device, such as a mainframe computer.

The power source 208 includes a source for providing power to the computing device 200. For example, the power source 208 can be an interface to an external power distribution system. In another example, the power source 208 can be a battery, such as where the computing device 200 is configured to operate independently of an external power distribution system.

The peripherals 210 includes one or more sensors, detectors, or other devices configured for monitoring the computing device 200 or the environment around the computing device 200. For example, the peripherals 210 can include a geolocation component, such as a global positioning system (GPS) location unit. In another example, the peripherals can include a temperature sensor for measuring temperatures of components of the computing device 200, such as the processor 202.

The user interface 212 includes one or more input or output components. Examples of input or output components of the user interface 212 include a display, such as a liquid crystal display (LCD), a cathode-ray tube (CRT), a light emitting diode (LED) display (e.g., an OLED display), or other suitable display; a positional input device, such as a mouse, touchpad, touchscreen, or the like; a keyboard; or other suitable human or machine interface devices.

The network interface 214 provides a connection or link to a network, for example, the Internet, a local area network (LAN), a wide area network (WAN), a virtual private network (VPN), or another public or private network. The network interface 214 can be a wired network interface or a wireless network interface. The computing device 200 can communicate with other devices (e.g., the vehicle 104 and the multi-user online platform 108 of FIG. 1) via the network interface 214 using one or more network protocols, such as Ethernet, TCP, IP, power line communication (PLC), Wi-Fi, infrared, GPRS, GSM, CDMA, or other suitable protocols.

Implementations of the computing device 200 of FIG. 2 can include additional, less, or combined functionality as compared to that described above, or functionality other than that described above, or combinations thereof. In some implementations, the computing device 200 can omit the peripherals 210. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

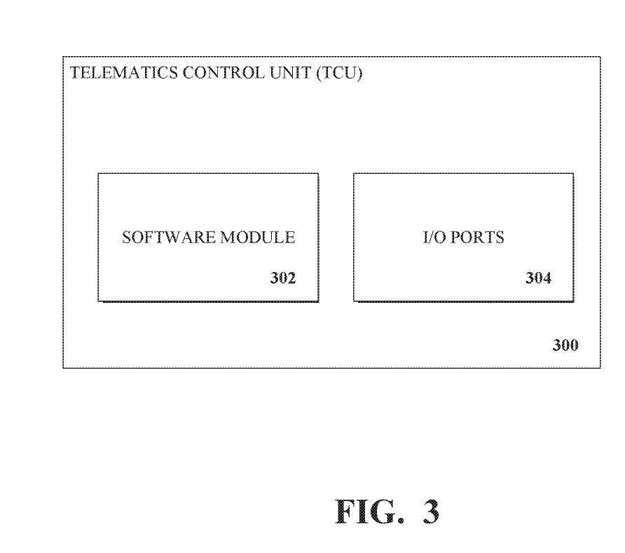

FIG. 3 illustrates an example of a telematic control unit 300 of a vehicle used for generating media content in accordance with implementations of this disclosure. The telematic control unit 300 comprises a plurality of hardware components, a software module 302 comprising a plurality of software applications, and input/output (I/O) components 304. The telematic control unit 300 can connect the vehicle (e.g., the vehicle 104 of FIG. 1) that includes the telematic control unit 300 to either another vehicle, to a cloud platform (e.g., the cloud platform 102 of FIG. 1), or to another device/system (e.g., a smartphone). The telematic control unit 300 can be embedded or part of the vehicle or can be coupled to or installed into the vehicle. The vehicle that includes the telematic control unit 300 can also be referred to as a connected vehicle. The telematic control unit 300 can be coupled to a plurality of different types of vehicles that vary in make and model.

The telematic control unit 300 can be connected to other vehicle sub-systems (e.g., other sub-systems of the connected vehicles) through a CAN bus to provide vehicle data associated with the connected vehicle. The plurality of hardware components can comprise a system-on-a-chip (SoC) (e.g., a Linux SoC, single board computers, computer on modules), a CAN bus (i.e., a CAN transceiver), a Bluetooth transceiver (or other wireless communication transceiver), a GPS sensor, a cellular modem (e.g., Verizon USB LTE modem), and other components in a variety of configurations. The plurality of hardware components can facilitate the communications between the connected vehicle that includes the telematic control unit 300 and the cloud platform that generates the media content and corresponding targeted messaging using the vehicle data. The telematic control unit 300 can record the vehicle data and transmit the vehicle data to the cloud platform using wireless communications. The software module 302 can include an application (e.g., a containerized Python app), an operating system (e.g., ResinOS), and other components. The I/O components 304 can include a cable to OBD2 port, an external GPS antenna, wireless components (e.g., Bluetooth, LTE, WiFi), and other components.

The telematic control unit 300 provides the vehicle data by filtering and receiving CAN messages from the vehicle sensors connected to the CAN bus (e.g., fuel level sensor, tire pressure sensor, etc.), sending CAN messages (e.g., to lock/unlock vehicle doors, open vehicle trunks), determining device and vehicle location, scanning for Bluetooth device MAC addresses in regular and low energy modes, and providing on the fly service reconfiguration (e.g., turn on/off, change service parameters). The telematic control unit 300 can always be on by being powered from the vehicle battery through the OBD2 port, provides low latency in message transfer, provides heartbeat messages for full visibility in fleet operations, and can disable CAN write mode when the vehicle is in drive or reverse. The telematic control unit 300 can receive automated over the air (OTA) updates using deploy pipelines (e.g., Resin.io deploy pipeline), can be visible as a device using dashboards (e.g., Resin.io dashboard), can have device configurations managed using a cloud platform, and can provide encrypted communications (MQTT over TLS).

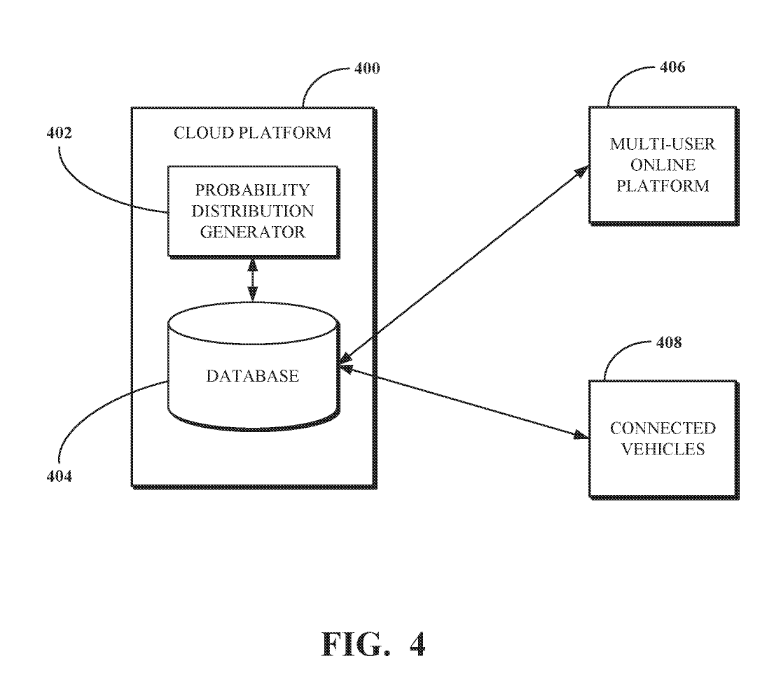

FIG. 4 illustrates a block diagram of an example generation of probability distributions by a cloud platform 400 (e.g., the cloud platform 100 of FIG. 1) in accordance with implementations of this disclosure. The cloud platform 400 includes a probability distribution generator 402 and a database 404. The cloud platform 400 can receive user data associated with a user from a multi-user online platform 406. The cloud platform 400 can also receive user data for each of a plurality of users and can separate each user data by user identification information. The user data can be stored within the database 404 of the cloud platform 400. The cloud platform 400 can receive vehicle data from connected vehicles 408. The vehicle data can also be stored within the same database 404 of the cloud platform 400 or a separate database. The user data and the vehicle data can be received by the cloud platform 400 from both the multi-user online platform 406 and each of the connected vehicles 408 using a variety of wireless and wired communication mechanisms including but not limited to Wi-Fi.

The probability distribution generator 402 of the cloud platform 400 can generate user probability distributions using the received user data and can generate vehicle probability distributions using the received vehicle data. The probability distribution generator 402 generates each user probability distribution by assigning predetermined tags (e.g., short trips, medium trips, long trips) to each piece of data of the received user data (corresponding to a single user), determining probability values associated with and using the tagged user data, and storing the determined probability values as a data structure (representing the user probability distribution) within the database 404.

For example, if a piece of data of the received user data is a user reposting a positive response to a camping trip image that would require a long journey, the piece of data can be assigned a “long trip” tag by the probability distribution generator 402. If there are three pieces of data within the received user data and each receives one tag (e.g., one short trip tag, one medium trip tag, one long trip tag), then the probability values would be determined by the probability distribution generator 402 to be 33% short trip, 33% medium trip, and 33% long trip (i.e., three probability values with one for each tag). The determined probability values can be stored within data structures that have a variety of formats including but not limited to data structures that identify the user associated with the user data in addition to identifying the corresponding probability value for each tag assigned to the user data. The probability distribution generator 402 can generate a user probability distribution for each user and the corresponding received user data of each user. For example, the cloud platform 400 can receive user data associated with five users of the multi-user online platform 406 and can generate, using the probability distribution generator 402, a separate user probability distribution for each of the five users (i.e., generating five user probability distributions).

The probability distribution generator 402 of the cloud platform 400 (or another generator of the cloud platform 400 that is not shown) can generate vehicle probability distributions using the received vehicle data. The probability distribution generator 402 generates the vehicle probability distributions by assigning similar predetermined tags (e.g., short trips, medium trips, long trips) to each piece of data of the received vehicle data, determining probability values associated with and using the tagged vehicle data, and storing the determined probability values as another data structure (each representing one of the vehicle probability distributions) within the database 404. The data structure used by the probability distribution generator 402 to generate each user probability distributions can have the same format as the data structure used by the probability distribution generator 402 to generate each vehicle probability distribution. In some implementations, the data structure differs between the user probability distributions and the vehicle probability distributions but can be mapped by the probability distribution generator 402. In some implementations, different tags are utilized between the user probability distributions and the vehicle probability distributions but the probability distribution generator 402 maps a relationship between the different tags.

The vehicle probability distributions can be segmented by a variety of characteristics including but not limited to location data and can be further clustered by grouping similar vehicle probability distributions together (e.g., using an averaging calculation or similar mechanism) to provide an outputted vehicle probability distribution representative of each cluster. For example, if the probability distribution generator 402 generates one hundred vehicle probability distributions (each vehicle probability distribution for one of one hundred vehicles located in four separate cities), the one hundred vehicle probability distributions can be segmented into four segments (i.e., one for each location or 25 vehicle probability distributions within each segmented location) by the probability distribution generator 402. Each segmented location can be clustered into a predetermined number (e.g., three) of clusters based on an analysis (i.e., the average calculation) by the probability distribution generator 402 of each of the vehicle probability distributions within each segment. For example, the one hundred vehicles can be represented by 12 total vehicle probability distributions if three clusters are chosen within each of the four segments based on the average calculation (i.e., the 25 vehicle probability distributions for each segment are calculated to be groupable into three clusters each based on relationships between each of the 25 vehicle probability distributions).

The total number of vehicle probability distributions generated and separated by both segments and clusters via the probability distribution generator 402 can be referred to as an aggregate vehicle probability distribution map. The probability distribution generator 402 or another module (not shown) of the cloud platform 400 can assign mobility levels to each of the corresponding clusters of the aggregate vehicle probability distribution map.

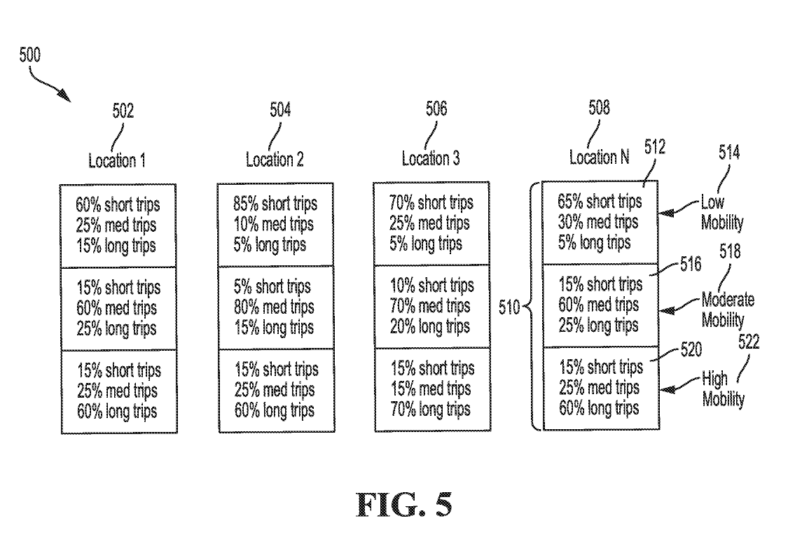

FIG. 5 illustrates a diagram of an example of an aggregate vehicle probability distribution map 500 in accordance with implementations of this disclosure. The aggregate vehicle probability distribution map 500 can be generated by a probability distribution generator of a cloud platform (e.g., the probability distribution generator 402 of the cloud platform 400) or another module of the cloud platform using the received vehicle data. The aggregate vehicle probability distribution map 500 is segmented by location and includes a first location 502, a second location 504, a third location 506, and an Nth location 508. Within each of the first location 502, the second location 504, the third location 506, and the Nth location 508, the aggregate vehicle probability distribution map 500 is clustered by probability values associated with vehicle probability distributions. In the aggregate vehicle probability distribution map 500, each location (the first location 502, the second location 504, the third location 506, and the Nth location 508) has three separate clusters but a variety of different cluster numbers (e.g., fewer, more than three) can be utilized based on a determination (e.g., average calculation) by the probability distribution generator.

Each cluster within each segment can be associated with a mobility level. For example, in the aggregate vehicle probability distribution map 500, the Nth location 508 has three separate clusters 510. A first cluster 512 of the three separate clusters 510 has a first vehicle probability distribution that includes three probability values comprising 65%, 30%, and 5%. The three probability values correspond to the tags utilized by the probability distribution generator which comprise short trips, medium trips, and long trips. Therefore, the first vehicle probability distribution for the first cluster 512 can be represented as 65% short trips, 30% medium trips, and 5% long trips. The first vehicle probability distribution for the first cluster 512 can correspond to a first mobility level 514 denoted as “low mobility” because the largest percentage of trips taken within this cluster are “short trips” (i.e., 65% short trips>30% medium trips; 65% short trips>5% long trips).

A second cluster 516 of the three separate clusters 510 has a second vehicle probability distribution comprising 15% short trips, 60% medium trips, and 25% long trips. The second vehicle probability distribution for the second cluster 516 can correspond to a second mobility level 518 denoted as “medium mobility” because the largest percentage of trips taken within this cluster are “medium trips”. A third cluster 520 of the three separate clusters 510 has a third vehicle probability distribution comprising 15% short trips, 25% medium trips, and 60% long trips. The third vehicle probability distribution for the third cluster 520 can correspond to a third mobility level 522 denoted as “high mobility” because the largest percentage of trips taken within this cluster are “long trips”.

In some implementations, a “low mobility” user or group includes mobility patterns (i.e., mobility levels) that are weighted towards short trips (e.g., commuting) or trips in relatively heavy traffic, and these users/groups have “home” locations that are suitable for short trips and higher than average traffic congestion. A “medium mobility” (also referred to as a “mixed mobility”) user or group includes mobility patterns that have a mix of long and short trips or mostly medium trips, and these users/groups have “home” locations that are suitable for mixed/medium trips. A “high mobility” user or group includes mobility patterns that are weighted towards long trips (e.g., adventure trips) and these users/groups have “home” locations that are suitable for long trips. In addition to user data received from multi-user online platforms, the cloud platform can utilize a variety of databases (e.g., government databases) to aggregate information regarding each user to help with the usage based segmentation in mobility levels.

The aggregate vehicle probability distribution map 500 is utilized for the matching between the user probability distribution associated with the user that is carried out by the cloud platform. Based on the matching, a mobility score can be generated that can be utilized to confirm the mobility level of the user and tailor the media content and corresponding targeted messaging that is generated by the cloud platform and displayed to the user.

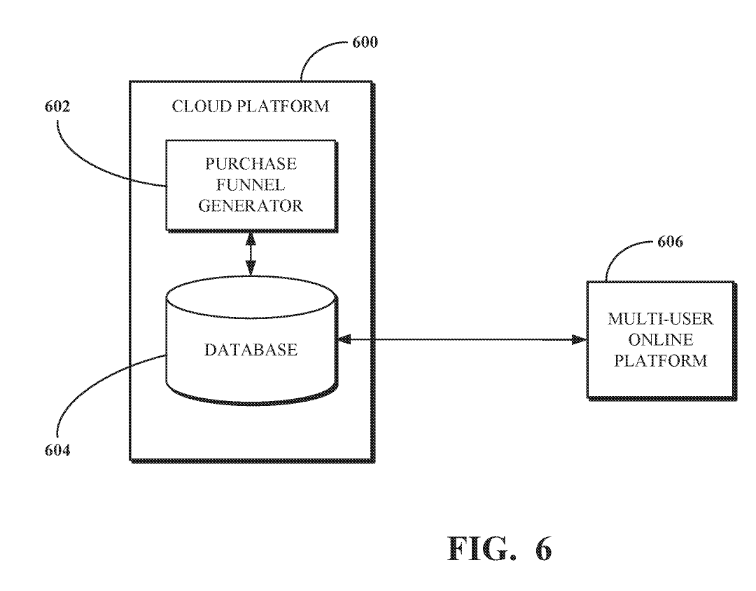

FIG. 6 illustrates a block diagram of an example generation of purchase funnel status data by a cloud platform 600 (e.g., the cloud platform 100 of FIG. 1) in accordance with implementations of this disclosure. The cloud platform 600 includes a purchase funnel generator 602 and a database 604 (e.g., the database 404 of FIG. 4 or a different database). The cloud platform 600 can receive user data associated with a user from a multi-user online platform 606. The user data can be stored within the database 604 of the cloud platform 600. The user data can be received by the cloud platform 600 from the multi-user online platform 606 using a variety of wireless and wired communication mechanisms including but not limited to Wi-Fi.

The purchase funnel generator 602 of the cloud platform 600 can generate purchase funnel status data using the received user data by providing text/content analytics (i.e., analyzing the content of the user data to determine various interest levels corresponding to the purchase funnel). The purchase funnel generator 602 generates each purchase funnel status data by assigning predetermined tags (e.g., commuter, outdoor enthusiast, frugal, green friendly, etc.) to each piece of data of the received user data (corresponding to a single user), determining the purchase funnel status data associated with and using the tagged user data, and storing the determined purchase funnel status data as a data structure (representing the purchase funnel status data) within the database 604. The purchase funnel status data and the corresponding user probability distribution can be stored within the same data structure or different data structures. A separate purchase funnel status data can be generated for each user to track each user's customer journey or path regarding the potential purchase of a product. For example, the purchase funnel status data can comprise a unique vehicle purchase funnel with long time cycles to track a user's vehicle purchasing journey.

The purchase funnel status data can identify that a user corresponds to a specific interest level regarding the purchase of the product. For example, the purchase funnel status data can identify that a user corresponds to one of five interest levels regarding the purchase of a vehicle (i.e., product) that can be stored as data values comprising an awareness data value, a familiarity data value, a consideration data value, a shopping data value, and a purchase data value. The purchase funnel status data can include different data values (i.e., fewer, more, different data values). Each of the five data values can correspond to an interest level or purchasing action associated with the vehicle. For example, the awareness data value can correspond to a “low interest” level, the familiarity data value can correspond to a “medium interest” level, the consideration data value can correspond to a “high interest” level, the shopping data value can correspond to an “extremely high interest” level, and the purchase data value can correspond to a confirmation of a purchase. The purchase funnel status data can be utilized by the cloud platform 600 in conjunction with the mobility level of the user (e.g., identified by the probability distribution generator when matching the user's user probability distribution to the aggregate vehicle probability distribution map) to generate media content and corresponding targeted messaging for the user. The purchase funnel status data can be stored as a sub-set data value within the same data structure that stores a mobility level associated with a user probability distribution of a user.

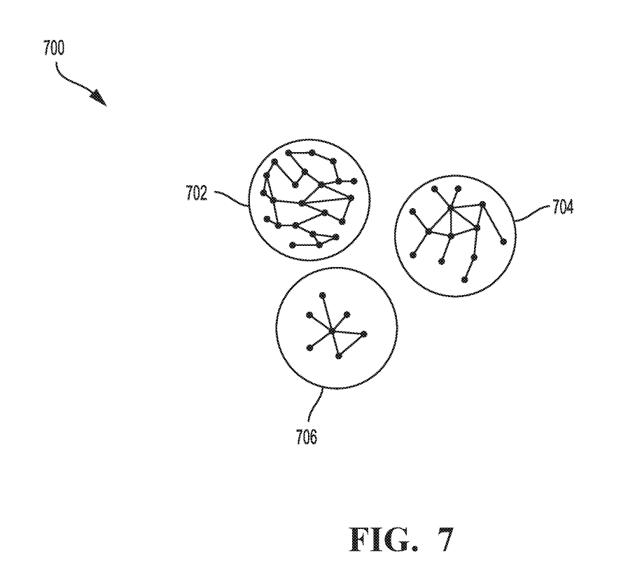

FIG. 7 illustrates a diagram of an example of a multi-user online platform cohesiveness distribution 700 in accordance with implementations of this disclosure. The multi-user online platform cohesiveness distribution 700 can be generated by a cloud platform (e.g., the cloud platform 100 of FIG. 1) using user data from a plurality of multi-user online platforms associated with a plurality of users. The multi-user online platform cohesiveness distribution 700 indicates which multi-user online platform of the plurality of multi-user online platforms that each user belongs to. Each multi-user online platform of the multi-user online platform cohesiveness distribution 700 can include a cohesiveness factor or value that relates/defines the connectedness of the respective multi-user online platform (i.e., how connected the multi-user online platform is). The connectedness of a multi-user online platform can be defined as a degree to which each user within the multi-user online platform is connected together based on a variety of bonds including but not limited to being related (e.g., siblings, parents, etc.), being friends on the multi-user online platform, interacting with each other on the multi-user online platform (e.g., following users, commenting on posts, etc.), and having similar interests with each other.

In FIG. 7, the multi-user online platform cohesiveness distribution 700 includes a first connectivity cluster 702 associated with a first multi-user online platform of the plurality of multi-user online platforms, a second connectivity cluster 704 associated with a second multi-user online platform of the plurality of multi-user online platforms, and a third connectivity cluster 706 associated with a third multi-user online platform of the plurality of multi-user online platforms. The first connectivity cluster 702 has a high connectivity value as denoted by a high number of bonds between various users of the first multi-user online platform. The second connectivity cluster 704 has a medium connectivity value as denoted by a medium number of bonds between various users of the second multi-user online platform. The third connectivity cluster 706 has a low connectivity value as denoted by a low number of bonds between various users of the third multi-user online platform. Each of the first, second, and third connectivity clusters 702-706 are generated using data and information between related or similar users of each corresponding multi-user online platform. As aforementioned, similarities or relationships between users can be identified using various bonds including but not limited to friends and connections on each multi-user online platform and can also be identified via usage patterns of each user. For example, a first user and a second user that are friends on the first multi-user online platform can be grouped within the first connectivity cluster 702.

Each of the first, second, and third connectivity clusters 702-706 can be continuously updated by the cloud platform so that a first user can be included within the first connectivity cluster 702 at a first time point and can be updated to be included within the second connectivity cluster 704 at a second time point. The media content that is generated by the cloud platform and transmitted to the user for exposure (i.e., consumption of a targeted advertisement that includes media content and corresponding targeted messaging) can also be based on which connectivity cluster the user has been assigned by the cloud platform. For example, if a user within the first connectivity cluster 702 was exposed to media content and corresponding targeted messaging that generated a favorable response, another user within the first connectivity cluster 702 can be exposed to the same (or similar) media content and corresponding targeted messaging.

The vehicle probability distributions and corresponding mobility levels of each cluster determined by the cloud platform (e.g., the probability distribution generator 404 of the cloud platform 400) using the vehicle data associated with a plurality of vehicles can be matched with the user probability distribution and corresponding mobility level of a user that is determined by the cloud platform (e.g., the probability distribution generator 404 of the cloud platform 400) using the user data associated with the user. The matching can result in a mobility score generated by the cloud platform. The mobility score can include at least two components comprising a nearest matching cluster (i.e., defined by mobility level) and a degree of fit.

When the mobility level of the user is matched to the mobility level of the clusters, the nearest matching cluster can be identified and a degree of fit can be calculated based on the vehicle probability distribution of the nearest matching cluster and the user probability distribution of the user. Based upon the generated mobility score denoting that there is a good fit between the user and the cluster, media content and corresponding targeted messaging can be generated by the cloud platform and transmitted to the user for viewing by the user (i.e., exposure via a multi-user online platform). A good fit can be determined using a predetermined threshold. For example, if the fit between the user and the cluster is determined to be 99% and the predetermined threshold is set at 95%, a good fit can be determined/confirmed so that when the cluster's mobility level is identified to be high mobility, media content and corresponding targeted messaging associated with a high mobility user is generated and transmitted to the user. In some implementations, the media content and the corresponding targeted messaging are generated together by the cloud platform (i.e., the media content includes the corresponding targeted messaging). In other implementations, the media content and the corresponding targeted messaging are generated separately by the cloud platform.

The mobility score can be part of media content selection parameters that are utilized by the cloud platform to generate the media content and the corresponding targeted messaging. The media content selection parameters can also include machine learning techniques that enable the cloud platform to automatically select and generate the media content and the corresponding targeted messaging from a database of previously generated media content and corresponding targeted messaging. For example, if a first user is in a similar connectivity cluster as a second user, one of the media content selection parameters generated by the cloud platform can be the identification of a previously successful digital marketing campaign used on the first user that included a specific media content and corresponding targeted messaging to enable the cloud platform to more efficiently transmit a similar media content and corresponding targeted messaging to the second user based on the media content selection parameters.

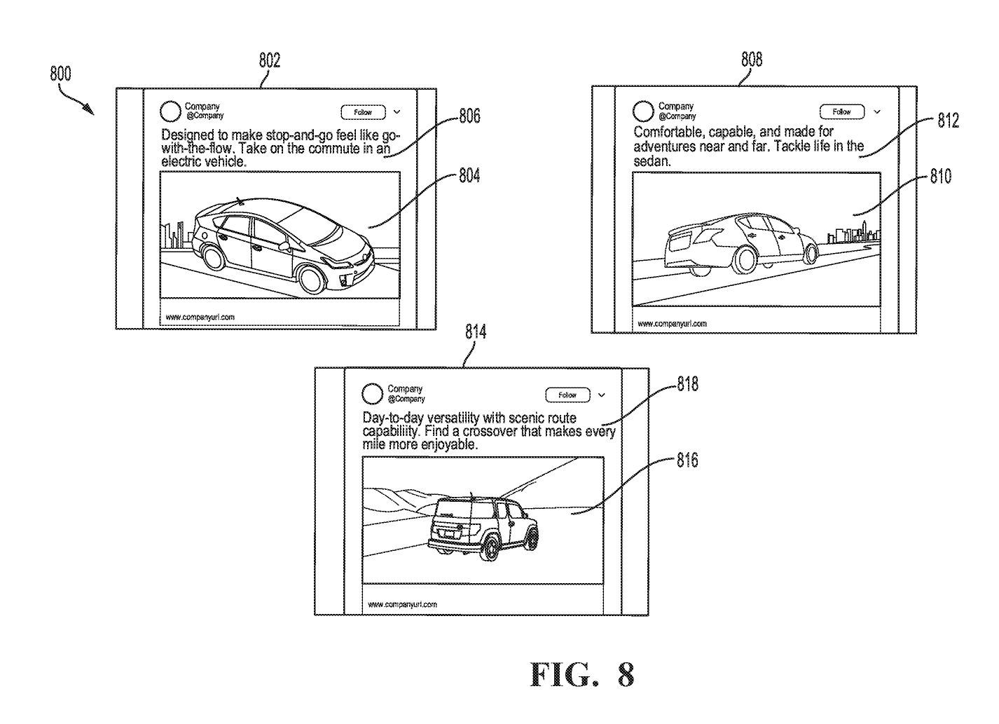

FIG. 8 illustrates a diagram of an example of a plurality of messages 800 that are each generated using media content selection parameters in accordance with implementations of this disclosure. The plurality of messages 800 can each be generated by a cloud platform (e.g., the cloud platform 100 of FIG. 1). The plurality of messages 800 can also be referred to as digital marketing campaigns. The plurality of messages 800 each include media content and corresponding targeted messaging that are each generated based upon the user's mobility level and corresponding media content selection parameters. The targeted messaging can comprise messages that are customized for exposure to a user to increase a likelihood of garnering a predetermined desired response from the user that receives the targeted messaging. Based on the determination of the mobility level of the user (or a group of users), the cloud platform generates the plurality of messages 800 to include the media content and the corresponding targeted messaging and then transmits the plurality of messages 800 to the user or the group of users (e.g., transmitted to a user of a multi-user online platform via the multi-user online platform). The media content (e.g., images, videos, etc.) and the corresponding targeted messaging (e.g., text-based advertisements) can be automatically generated or selected using machine learning techniques by the cloud platform from a repository or database of media content and messaging options. The words selected for generation in the corresponding targeted messaging can be determined using feedback testing and data aggregation of previously successful and unsuccessful campaigns.

A first message 802 of the plurality of messages 800 includes a first media content 804 and a first corresponding targeted messaging 806 that have been generated by the cloud platform in response to a determination that a mobility level of a user (or group of users) is “low mobility”. Accordingly, the first media content 804 displays an image of an electric type vehicle that is good for commuting and the first corresponding targeted messaging 806 is automatically generated and customized to highlight words that include “stop-and-go” and “commute”. For example, the cloud platform can be operated by a vehicle manufacturer to display the first message 802 to a low mobility user thereby increasing an interest level (e.g., a purchasing interest level) of the low mobility user in a vehicle (i.e., the electric type vehicle) associated with the vehicle manufacturer.

A second message 808 of the plurality of messages 800 includes a second media content 810 and a second corresponding targeted messaging 812 that have been generated by the cloud platform in response to a determination that a mobility level of a user (or a group of users) is “medium mobility”. Accordingly, the second media content 810 displays an image of a sedan type vehicle driving into the city and the second corresponding targeted messaging 812 is automatically generated and customized to highlight words that include “comfortable” and “near and far”. For example, the cloud platform can be operated by a vehicle manufacturer to display the second message 808 to a medium mobility user thereby increasing an interest level (e.g., a purchasing interest level) of the medium mobility user in a vehicle (i.e., the sedan type vehicle) associated with the vehicle manufacturer.

A third message 814 of the plurality of messages 800 includes a third media content 816 and a third corresponding targeted messaging 818 that have been generated by the cloud platform in response to a determination that a mobility level of a user (or a group of users) is “high mobility”. Accordingly, the third media content 816 displays an image of a SUV type vehicle climbing a snowy terrain and the third corresponding targeted messaging 818 is tailored to highlight words that include “versatility” and “scenic routes”. For example, the cloud platform can be operated by a vehicle manufacturer to display the third message 814 to a high mobility user thereby increasing an interest level (e.g., a purchasing interest level) of the high mobility user in a vehicle (i.e., the SUV type vehicle) associated with the vehicle manufacturer.

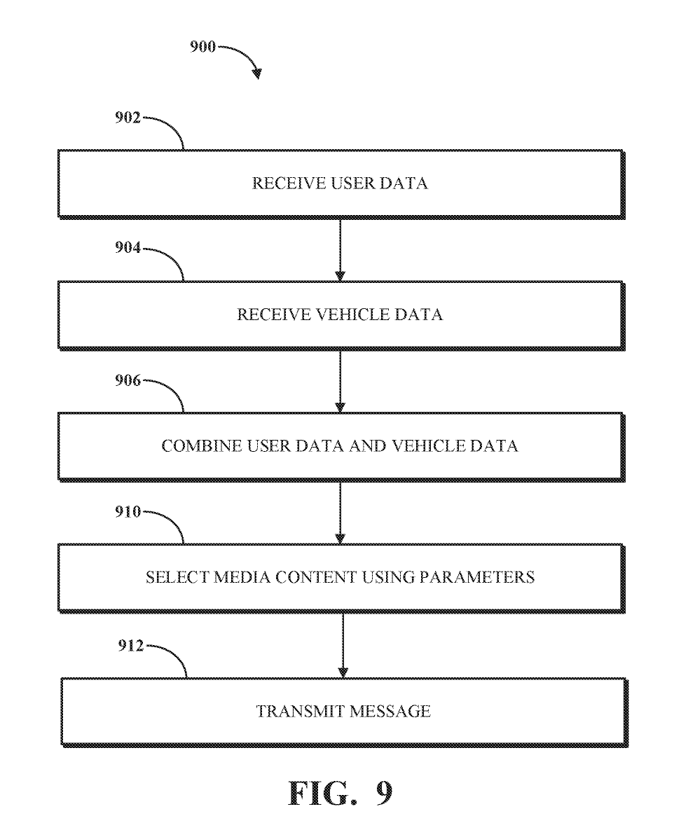

FIG. 9 illustrates a flowchart of an example of a method 900 for generating media content using user data and vehicle data in accordance with implementations of this disclosure. The method 900 can be executed using computing devices, such as the systems, modules, and devices described with respect to FIGS. 1-3 (e.g., the cloud platform 100 of FIG. 1). The method 900 can be performed, for example, by executing a machine-readable program or other computer-executable instructions, such as instructions or programs described according to JavaScript, C, or other such instructions. The steps, or operations, of the method 900 or any other technique, method, process, or algorithm described in connection with the implementations disclosed herein can be implemented directly in hardware, firmware, software executed by hardware, circuitry, or a combination thereof.

The method 900 includes receiving user data, via operation 902. The user data can be received by a cloud platform from one user on one multi-user online platform (e.g., a social media platform or a social network such as Twitter), from a plurality of users on one multi-user online platform, or from a plurality of users on a plurality of multi-user online platforms. The method 900 includes receiving vehicle data, via operation 904. The vehicle data can be received by the cloud platform from one vehicle, from a plurality of vehicles in one location, or from a plurality of vehicles in multiple locations. The method 900 includes combining the received user data and the received vehicle data, via operation 906, and selecting a media content using parameters, via operation 908. The parameters can be outputted by the cloud platform in response to the combination of the user and vehicle data. The method 900 includes transmitting a message, via operation 910. The message can be transmitted by the cloud platform to at least one of the users of the multi-user online platform. The message can include the selected media content (e.g., customized media and messaging that is targeted a specific audience and/or user type) and additional information including but not limited to metadata.

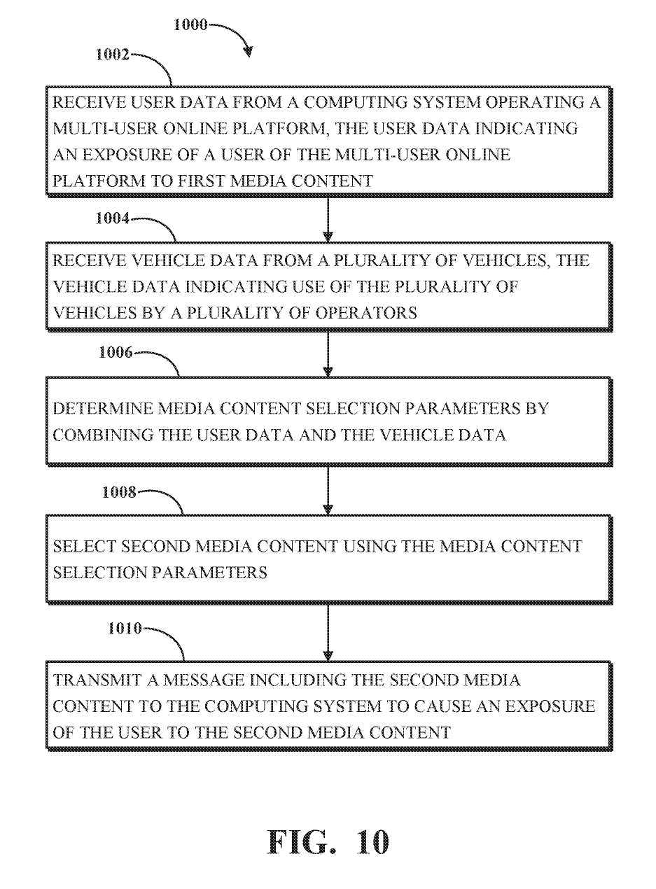

FIG. 10 illustrates a flowchart of an example of a method 1000 for generating media content using user data and vehicle data in accordance with implementations of this disclosure. The method 1000 can be executed using computing devices, such as the systems, modules, and devices described with respect to FIGS. 1-3 (e.g., the cloud platform 100 of FIG. 1). The method 1000 can be performed, for example, by executing a machine-readable program or other computer-executable instructions, such as instructions or programs described according to JavaScript, C, or other such instructions. The steps, or operations, of the method 1000 or any other technique, method, process, or algorithm described in connection with the implementations disclosed herein can be implemented directly in hardware, firmware, software executed by hardware, circuitry, or a combination thereof.

The method 1000 includes receiving user data from a computing system operating a multi-user online platform, via operation 1002. The user data can be received by a cloud platform. The user data indicates an exposure of a user of the multi-user online platform to first media content. The first media content can comprise any combination of text, images, and videos that is displayed to the user via the multi-user online platform. For example, the user data that indicates the exposure of the user of the multi-user online platform can comprise responses (e.g., social interactions and associated information such as comments, likes, retweets, posts, hashtags, location data, usage data, etc.) carried out on the multi-user online platform by the user in response to the first media content. In some implementations, the method 1000 receives user data from a plurality of users that are each using a multi-user online platform (i.e., either the same multi-user online platform or different ones).

The method 1000 includes receiving vehicle data from a plurality of vehicles, via operation 1004. The vehicle data can be received by the cloud platform. The vehicle data indicates use of the plurality of vehicles by a plurality of operators. For example, the vehicle data that indicates the user of the plurality of vehicles by the plurality of operators can comprise trip information (e.g., distance traveled, direction traveled, duration traveled, etc.) associated with trips carried out on the plurality of vehicles by the plurality of operators. The vehicle data includes information associated with each of the plurality of vehicles that can be determined using a separate telematic control unit (TCU) or similar connected device associated with each of the plurality of vehicles. In some implementations, the cloud platform only receives a subset of the vehicle data (e.g., from only one vehicle, from only one location, from only one time period) based on predetermined inputs.

The method 1000 includes determining media content selection parameters by combining the user data and the vehicle data, via operation 1006. In some implementations, determining media content selection parameters by combining the user data and the vehicle data can comprise determining a user probability distribution using the user data, determining a plurality of vehicle probability distributions using the vehicle data, matching the user probability distribution to a corresponding mobility level of a plurality of mobility levels associated with the plurality of vehicle probability distributions, and determining the media content selection parameters using the corresponding mobility level.

In some implementations, determining a user probability distribution using the user data can comprise assigning one of a plurality of tags to each data of the user data to provide a plurality of tagged user data, determining a first set of probability values using the plurality of tagged user data, each probability value of the first set of probability values corresponding to one of the plurality of tags, and storing the first set of probability values as a first data structure within a database of the memory, the first data structure serving as the user probability distribution. The plurality of tags can comprise a short trip tag, a medium trip tag, and a long trip tag.

In some implementations, determining a plurality of vehicle probability distributions using the vehicle data can comprise assigning one of the plurality of tags to each data of the vehicle data to provide a plurality of tagged vehicle data, determining a second set of probability values for each of the plurality of vehicles using the plurality of tagged vehicle data, each probability value of the second set of probability values corresponding to one of the plurality of tags, and storing each of the second set of probability values as one of a plurality of second data structures within the database of the memory, the plurality of second data structures serving as the plurality of vehicle probability distributions.

The method 1000 includes selecting second media content using the media content selection parameters, via operation 1008, and transmitting a message that includes the second media content to the computing system to cause an exposure of the user to the second media content, via operation 1010. The second media content can comprise media (e.g., an image or video) that is customized using the media content selection parameters and that corresponds to customized text of the message. The message can be targeted (i.e., transmitted for exposure) to a receiver (i.e., specific audience and/or user type) to aid a sender (e.g., vehicle manufacturer) of the message in garnering a predetermined desired response (e.g., purchasing the vehicle manufacturer's vehicle) from the receiver (e.g., person interested in purchasing a vehicle) of the message.

In some implementations, the method 1000 further includes segmenting each of the plurality of vehicle probability distributions into one of a plurality of segmentations using a segmentation value associated with the vehicle data, clustering each of the plurality of vehicle probability distributions within each of the plurality of segmentations into one of a plurality of clusters using each of the second set of probability values, determining a third set of probability values for each of the plurality of clusters, each probability value of the third set of probability values corresponding to one of the plurality of tags, storing each of the third set of probability values as one of a plurality of third data structures within the database of the memory, and assigning one of the plurality of mobility levels to each of the plurality of clusters. The segmentation value can be a geographic location comprising any of a city, a state, and a country data value.

In some implementations, matching the user probability distribution to a corresponding mobility level of a plurality of mobility levels associated with the plurality of vehicle probability distributions can comprise determining one of the plurality of clusters that is a nearest matching cluster to the user probability distribution using the first data structure associated with the user probability distribution and each of the plurality of third data structures associated with the plurality of clusters, determining a degree of fit between the first set of probability values associated with the user probability distribution and a third set of probability values associated with the nearest matching cluster, generating a mobility score comprising the nearest matching cluster as a first component and the degree of fit as a second component, and, in response to the mobility score being above a predetermined threshold, matching the user probability distribution to the corresponding mobility level that is associated with the nearest matching cluster.

In some implementations, the user data can comprise any of location data, text data, image data, video data, audio data, network data, profile data, and metadata. The vehicle data can comprise telematics data from a plurality of telematics units (also referred to as telematic control units) that are each associated with one of the plurality of vehicles. The telematics data can comprise any of location data, trip data, journey data, weather data, vehicle health data, and vehicle communication data. The first media content can be associated with a marketing campaign electronic record accessible within the multi-user online platform.

The present disclosure provides a system that can carry out the aforementioned operations or steps of the method 900 of FIG. 9 and the method 1000 of FIG. 10. The system comprises a memory and a processor. The processor executes instructions stored in the memory to carry out the aforementioned operations or steps of the methods 900/1000.

The implementations of this disclosure can be described in terms of functional block components and various processing operations. Such functional block components can be realized by any number of hardware or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “mechanism,” “module,” or “monitor” as used herein and in the figures may be understood as corresponding to a functional unit implemented using software, hardware (e.g., an ASIC), or a combination of software and hardware. In certain contexts, such mechanisms, modules, or monitors may be understood to be a processor-implemented software mechanism, processor-implemented software module, or software-implemented monitor that is part of or callable by an executable program, which may itself be wholly or partly composed of such linked mechanisms, modules, or monitors.

Implementations or portions of implementations of the above disclosure can take the form of a computer program product accessible from, for example, a computer-usable or computer-readable storage medium. A computer-usable or computer-readable storage medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include RAM or other volatile memory or storage devices that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed:

1. A system, comprising:
a memory; and
a processor, wherein the processor executes instructions stored in the memory to:
receive user data from a computing system operating a multi-user online platform, the user data indicating an exposure of a user of the multi-user online platform to first media content;
receive vehicle data from a plurality of vehicles, the vehicle data indicating use of the plurality of vehicles by a plurality of operators;
determine media content selection parameters by combining the user data and the vehicle data;
select second media content using the media content selection parameters; and
transmit a message including the second media content to the computing system to cause an exposure of the user to the second media content.

2. The system of claim 1, wherein the instructions to determine media content selection parameters by combining the user data and the vehicle data include instructions to:
determine a user probability distribution using the user data;
determine a plurality of vehicle probability distributions using the vehicle data;
match the user probability distribution to a corresponding mobility level of a plurality of mobility levels associated with the plurality of vehicle probability distributions; and
determine the media content selection parameters using the corresponding mobility level.

3. The system of claim 2, wherein the instructions to determine a user probability distribution using the user data include instructions to:
assign one of a plurality of tags to each data of the user data to provide a plurality of tagged user data;
determine a first set of probability values using the plurality of tagged user data, each probability value of the first set of probability values corresponding to one of the plurality of tags; and
store the first set of probability values as a first data structure within a database of the memory, the first data structure serving as the user probability distribution.

4. The system of claim 3, wherein the plurality of tags comprises a short trip tag, a medium trip tag, and a long trip tag.

5. The system of claim 3, wherein the instructions to determine a plurality of vehicle probability distributions using the vehicle data include instructions to:
assign one of the plurality of tags to each data of the vehicle data to provide a plurality of tagged vehicle data;
determine a second set of probability values for each of the plurality of vehicles using the plurality of tagged vehicle data, each probability value of the second set of probability values corresponding to one of the plurality of tags; and
store each of the second set of probability values as one of a plurality of second data structures within the database of the memory, the plurality of second data structures serving as the plurality of vehicle probability distributions.

6. The system of claim 5, wherein the processor executes further instructions stored in the memory to:
segment each of the plurality of vehicle probability distributions into one of a plurality of segmentations using a segmentation value associated with the vehicle data;
cluster each of the plurality of vehicle probability distributions within each of the plurality of segmentations into one of a plurality of clusters using each of the second set of probability values;
determine a third set of probability values for each of the plurality of clusters, each probability value of the third set of probability values corresponding to one of the plurality of tags;
store each of the third set of probability values as one of a plurality of third data structures within the database of the memory; and
assign one of the plurality of mobility levels to each of the plurality of clusters.

7. The system of claim 6, wherein the segmentation value is a geographic location comprising any of a city, a state, and a country.

8. The system of claim 6, wherein the instructions to match the user probability distribution to a corresponding mobility level of a plurality of mobility levels associated with the plurality of vehicle probability distributions include instructions to:
determine one of the plurality of clusters that is a nearest matching cluster to the user probability distribution using the first data structure associated with the user probability distribution and each of the plurality of third data structures associated with the plurality of clusters;
determine a degree of fit between the first set of probability values associated with the user probability distribution and a third set of probability values associated with the nearest matching cluster;
generate a mobility score comprising the nearest matching cluster as a first component and the degree of fit as a second component; and
in response to the mobility score being above a predetermined threshold, match the user probability distribution to the corresponding mobility level that is associated with the nearest matching cluster.

9. The system of claim 1, wherein the user data comprises any of location data, text data, image data, video data, audio data, network data, profile data, and metadata.

10. The system of claim 1, wherein the vehicle data comprises telematics data from a plurality of telematics units that are each associated with one of the plurality of vehicles.

11. The system of claim 10, wherein the telematics data comprises any of location data, trip data, journey data, weather data, vehicle health data, and vehicle communication data.

12. The system of claim 1, wherein the first media content is associated with a marketing campaign electronic record accessible within the multi-user online platform.

13. A method, comprising:
receiving user data from a computing system operating a multi-user online platform, the user data indicating an exposure of a user of the multi-user online platform to first media content;
receiving vehicle data from a plurality of vehicles, the vehicle data indicating use of the plurality of vehicles by a plurality of operators;
determining media content selection parameters by combining the user data and the vehicle data;
selecting second media content using the media content selection parameters; and
transmitting a message including the second media content to the computing system to cause an exposure of the user to the second media content.

14. The method of claim 13, wherein determining media content selection parameters by combining the user data and the vehicle data comprises:
determining a user probability distribution using the user data;
determining a plurality of vehicle probability distributions using the vehicle data;
matching the user probability distribution to a corresponding mobility level of a plurality of mobility levels associated with the plurality of vehicle probability distributions; and
determining the media content selection parameters using the corresponding mobility level.

15. The method of claim 14, wherein determining a user probability distribution using the user data comprises:
assigning one of a plurality of tags to each data of the user data to provide a plurality of tagged user data;
determining a first set of probability values using the plurality of tagged user data, each probability value of the first set of probability values corresponding to one of the plurality of tags; and
storing the first set of probability values as a first data structure within a database of the memory, the first data structure serving as the user probability distribution.

16. The method of claim 15, wherein determining a plurality of vehicle probability distributions using the vehicle data comprises:
assigning one of the plurality of tags to each data of the vehicle data to provide a plurality of tagged vehicle data;
determining a second set of probability values for each of the plurality of vehicles using the plurality of tagged vehicle data, each probability value of the second set of probability values corresponding to one of the plurality of tags; and
storing each of the second set of probability values as one of a plurality of second data structures within the database of the memory, the plurality of second data structures serving as the plurality of vehicle probability distributions.

17. The method of claim 16, further comprising:
segmenting each of the plurality of vehicle probability distributions into one of a plurality of segmentations using a segmentation value associated with the vehicle data;
clustering each of the plurality of vehicle probability distributions within each of the plurality of segmentations into one of a plurality of clusters using each of the second set of probability values;
determining a third set of probability values for each of the plurality of clusters, each probability value of the third set of probability values corresponding to one of the plurality of tags; and
storing each of the third set of probability values as one of a plurality of third data structures within the database of the memory; and
assigning one of the plurality of mobility levels to each of the plurality of clusters.

18. The method of claim 17, wherein matching the user probability distribution to a corresponding mobility level of a plurality of mobility levels associated with the plurality of vehicle probability distributions comprises:
determining one of the plurality of clusters that is a nearest matching cluster to the user probability distribution using the first data structure associated with the user probability distribution and each of the plurality of third data structures associated with the plurality of clusters;
determining a degree of fit between the first set of probability values associated with the user probability distribution and a third set of probability values associated with the nearest matching cluster;
generating a mobility score comprising the nearest matching cluster as a first component and the degree of fit as a second component; and
in response to the mobility score being above a predetermined threshold, matching the user probability distribution to the corresponding mobility level that is associated with the nearest matching cluster.

19. A non-transitory computer-readable storage medium, wherein the non-transitory computer-readable storage medium includes executable instructions that, when executed by a processor, facilitate performance of operations, the operations comprising:
receiving user data from a computing system operating a multi-user online platform, the user data indicating an exposure of a user of the multi-user online platform to first media content;
receiving vehicle data from a plurality of vehicles, the vehicle data indicating use of the plurality of vehicles by a plurality of operators;
determining media content selection parameters by combining the user data and the vehicle data;
selecting second media content using the media content selection parameters; and
transmitting a message including the second media content to the computing system to cause an exposure of the user to the second media content.

20. The non-transitory computer-readable storage medium of claim 19, wherein determining media content selection parameters by combining the user data and the vehicle data comprises:
determining a user probability distribution using the user data;
determining a plurality of vehicle probability distributions using the vehicle data;
matching the user probability distribution to a corresponding mobility level of a plurality of mobility levels associated with the plurality of vehicle probability distributions; and
determining the media content selection parameters using the corresponding mobility level.
